(19) United States
(12) Patent Application Publication
(10) Pub. No.: US 2021/0106030 A1
(43) Pub. Date: Apr. 15, 2021

(54) PROCESS FOR PROCESSING MANDARIN SEGMENTS WITH BOTH ACIDIC AND ALKALINE PROCESS WATER BEING DIRECTLY UTILIZED

(71) Applicant: ZHEJIANG UNIVERSITY, Zhejiang (CN)

(72) Inventors: Xingqian Ye, Zhejiang (CN); Jianle Chen, Zhejiang (CN); Shiguo Chen, Zhejiang (CN)

(73) Assignee: ZHEJIANG UNIVERSITY, Zhejiang (CN)

(21) Appl. No.: 16/958,668

(22) PCT Filed: Jan. 13, 2020
(86) PCT No.: PCT/CN2020/071622

§ 371 Date: Jun. 26, 2020

(30) Foreign Application Priority Data
Jun. 20, 2019 (CN) 201910539152.1

(51) Int. Cl. A23L 5/00; A23L 2/02; A23L 19/00

(52) U.S. Cl. CPC A23L 5/57; A23L 19/03; A23L 2/02

(57) ABSTRACT

A process for processing mandarin segments with both acidic and alkaline process water being directly utilized uses an organic acid or an inorganic polyacid instead of a monobasic inorganic acid. Mandarin segments, obtained by separating peeled mandarin into the segments, are treated by the organic acid or inorganic polyacid solution, and then subjected to removal of segment membranes in an alkali solution. The acidic and alkaline water after treatment is collected directly. The collected water can then be filtered and mixed for making an electrolyte beverage or a beverage base, containing multiple functional ingredients such as pectin, flavonoid, pigment, and limonin. Also, the collected water can be used to make dietary fiber having an activity of improving intestinal function.

This application claims priority to Chinese application No. 201910539152.1 filed Jun. 20, 2019 with a title of PROCESS FOR PROCESSING MANDARIN SEGMENTS WITH BOTH ACIDIC AND ALKALINE PROCESS WATER BEING DIRECTLY UTILIZED, the disclosure of which is incorporated herein by reference in its entirety.

### TECHNICAL FIELD

The present invention relates to processing of canned mandarins, and in particular to a process for processing mandarin segments with both acidic and alkaline process water being directly utilized.

### BACKGROUND

Mandarin oranges or mandarins are the most popular fruit in the world. China is a large producer of the mandarins, and also the biggest producer of canned mandarins in light syrup since the significant industrial advantages thereof. The can products are exported largely to countries or regions such as Japan, America and Europe.

A process for producing canned mandarins includes selecting and grading raw material of the mandarin oranges, peeling the mandarin oranges, dividing the peeled mandarin oranges into segments, removing segment membranes, rinsing, sorting and canning the segments, adding syrup into the cans, sealing, sterilizing and cooling the cans, etc. Removal of the membranes of the segments or slices, as a particularly important step, can provide better taste. A conventional process for removing the segment membranes uses hydrochloric acid and sodium hydroxide (BangYing LIANG, Canning Industry Manual. China Light Industry Press), and thus produces large amounts of acidic and alkaline wastewater with a high Chemical Oxygen Demand (COD) concentration, the treatment of which is very difficult and expensive and leads to a high-cost industry.

The segment membranes contain a large amount of polysaccharides such as pectin and hemicellulose, and also contain multiple functional ingredients such as flavone, pigment, limonin and synephrine. Polysaccharide is an excellent dietary fiber. Pectin can effectively prevent absorption of exogenous cholesterol, promote excretion of neutral cholesterol and cholesterol in liver, and exhibit a strong inhibiting effect on an increase in serum cholesterol and cholesterol in liver.

The multiple functional ingredients, such as flavone, pigment, limonin and synephrine, have been reported to have functions such as serum cholesterol reducing, hypolipidemic, blood pressure lowering, blood glucose regulating, and weight losing actions.

Therefore, if the above process water with a high COD concentration could be directly used to make a beverage or other series products, the amount of the wastewater to be discharged would be reduced and added-value of the mandarin oranges processing technology would be improved.

However, when the conventional acidic wastewater is neutralized with the conventional alkaline wastewater, a high concentration sodium chloride (NaCl) solution is produced. Such a product with a high concentration of NaCl is substantially salty and cannot be drunk directly. Moreover, other halogen compounds may be present in the product, leading to a risk of having new residue present in the product. On the other hand, due to the large amount of pectin present in the acidic and alkaline wastewater with a high COD level, the product cannot be desalted using membrane or other technologies.

### SUMMARY

In view of the above problems that the wastewater is difficult to be treated and contains a large amount of usable functional ingredients, an objective of the invention is to provide a process for processing mandarin segments with both acidic and alkaline process water being directly utilized. This direct utilization of the acidic and alkaline process water is achieved by an improved process of the segment membranes removal.

The above objective of the invention is realized by a process for processing mandarin segments comprising steps of:

(1) blanching and peeling a mandarin fruit or mandarin, and dividing the peeled mandarin into segments, followed by soaking the segments in an organic acid or inorganic polyacid solution at a concentration of 0.1 to 1.0 wt % such that the segments are completely submerged within the solution, and then stirring the mixture for 20 to 100 minutes at a temperature of 10 to 50° C.;

(2) removing the segments processed at the step (1) from the solution and rinsing the segments with clean water, followed by soaking the segments in an alkali solution at a concentration of 0.1 to 0.9 wt % such that the segments are completely submerged within the alkali solution, and then stirring the mixture for 10 to 50 minutes at a temperature of 10 to 50° C. to obtain the segments without a membrane;

(3) mixing acidic water discharged in the step (1) and alkaline water discharged in the step (2) and then canning the mixed water; wherein, any ratio of both can be contemplated, as far as the mixed water can have a pH value within a reasonable range.

Further, the mandarin fruit or mandarin may include fruit of all Citrus species and hybrid varieties thereof other than kumquat and trifoliate orange.

Further, in the step (1), the segments may be firstly soaked in an organic acid or inorganic polyacid solution at a concentration of 0.1 to 0.3 wt % followed by stirring for 10 to 30 minutes at a temperature of 10 to 30° C., and then the concentration of the acid solution may be increased to 0.3 to 1.0 wt % followed by further stirring for 10 to 70 minutes at a temperature of 30 to 50° C.

Further, the organic acid in the step (1) may include citric acid, malic acid, tartaric acid, oxalic acid, succinic acid, lactic acid, acetic acid and the like. The inorganic polyacid may include phosphoric acid.

Further, the alkali solution in the step (2) may include sodium hydroxide and potassium hydroxide solutions.

Further, the mixed water in the step (3) may have a pH value within a range of 1.5 to 9. The mixed water may be subjected to filtration with a screen having a mesh size in a range of 40 to 100 mesh to give a filtrate which can be directly used to make a beverage, a concentrated beverage or a beverage base, or be processed into a functional food additive including dietary fiber and prebiotics.

Further, the organic acid or inorganic polyacid solution used in the step (1) may include an aqueous organic acid solution or an aqueous inorganic polyacid solution, respectively.

Further, the alkali solution used in the step (2) may include an aqueous sodium hydroxide solution or an aqueous potassium hydroxide solution.

Further, in the step (1), after being stirred for 20 to 100 minutes at 10 to 50° C. the mixture may be subjected to solid-liquid separation so as to obtain the segments and the acidic water.

Further, in the step (2), after being stirred for 10 to 50 minutes at 10 to 50° C., the mixture may be subjected to solid-liquid separation so as to obtain the segments without a membrane and the alkaline water.

The present invention can provide advantages as follows. The process of the invention employs an organic acid or an inorganic polyacid instead of conventional inorganic acids and bases to process the segments, and enables efficient removal of the segment membranes to be achieved and the acidic and alkaline water discharged to be directly mixed for further use. The mixed water is enriched in not only electrolytes, especially salt electrolytes having buffering effect, such as sodium citrate or potassium citrate, but also multiple functional ingredients including polysaccharides such as pectin, flavonoids, pigments such as carotenoid and terpenes such as limonin. Such a mixed water can be directly used to make an electrolyte beverage, a beverage base or dietary fiber, leading to full utilization of the mixed water. No high concentration acidic or alkaline wastewater can be produced by using the process of the invention to process the segments, which can relieve the environment, and improve enterprise comprehensive benefit. So, the present invention opens new avenues to achieve green production, and improves profits of plants for processing the mandarin oranges. Moreover, the process is suitable to mechanized and mass scale production, since the process of the invention is simple, economic and safe.

### DETAILED DESCRIPTION

An organic acid or an inorganic polyacid is able to dissociate into acid ions and hydrogen ions, and when being mixed with the alkaline process water, is able to form a salt electrolyte. The process water so formed has a good taste with no apparently salty flavour and can be directly used to make a beverage. Electrolytes such as sodium citrate, potassium citrate, or potassium phosphate can be formed as main ingredients of the electrolyte beverage known as an isotonic beverage.

The invention will be explained in more detail by means of specific exemplary embodiments. It should be understood that the exemplary embodiments are intended for purposes of illustration only and are not intended to limit the scope of the invention. Moreover, it will be apparent to those skilled in the art that, on the basis of the description, various modifications or variations may be made in the present invention and various equivalents are also encompassed within the scope of the invention.

### Example 1

(1) blanching and peeling an Owari satsuma mandarin orange and a sweet orange, and dividing the peeled mandarins into segments, followed by soaking the segments in a 0.35 wt % citric acid solution, and then stirring the mixture for 50 minutes at 30° C.;

(2) removing the segments processed at the step (1) from the solution and rinsing the segments with clean water, followed by soaking the segments in a 0.1 wt % sodium hydroxide solution, and then stirring the mixture for 10 minutes at 50° C. to obtain the segments without a membrane;

(3) rinsing the segments without a membrane obtained in the step (2) with clean water followed by subjecting to a canning process, and mixing acidic process water discharged in the step (1) and alkaline process water discharged in the step (2) to form a mixed water with a pH of 8 which was directly used to make a beverage in a sterile workshop.

The process of the invention used an organic acid to loosen the segment membranes. The citric acid and sodium hydroxide in the mixed water reacted with each other to generate sodium citrate, which is an ingredient of an electrolyte beverage with some efficacy and is edible. The table below gives main ingredients of the mixed water and its sensory evaluation.

| | |
|---|---|
| Pectin (%) | 0.23 |
| Insoluble dietary fiber (%) | 0.48 |
| Sodium citrate (%) | 0.11 |
| Total flavonoids (determined | 110 |
| by the Davis method) | |
| mg/1000 g | |
| Appearance | with slight precipitation, pale yellow |
| | in color, nonhomogeneous and cloudy. |
| Taste | granular or particulate mouthfeel, |
| | neutral pH, and thin and light in texture |

It can be seen from the table that the mixed water contained nutraceutical ingredients such as pectin and flavonoids and no harmful substance, and was safe and healthy. In addition, the mixed water, subjected to no filtration, contained a relatively large amount of insoluble dietary fiber and had a granular or particulate mouthfeel.

### Example 2

(1) blanching and peeling an Owari satsuma mandarin orange and a sweet orange, and dividing the peeled mandarins into segments, followed by soaking the segments in a 0.1 wt % citric acid solution, and then stirring the mixture for 10 minutes at 30° C.; increasing the concentration of the citric acid solution to 0.8 wt % followed by further stirring for 40 minutes at 50° C.:

(2) removing the segments processed at the step (1) from the solution and rinsing the segments with clean water, followed by soaking the segments in a 0.1 wt % sodium hydroxide solution, and then stirring the mixture for 10 minutes at 50° C. to obtain the segments without a membrane;

(3) rinsing the segments without a membrane obtained in the step (2) with clean water followed by subjecting to a canning process, and mixing acidic process water discharged in the step (1) and alkaline process water discharged in the step (2) to form a mixed water with a pH of 4 which was filtered via a 100 mesh screen, with a filtrate directly used to make a beverage in a sterile workshop; wherein, some of the beverage was concentrated to dryness to form a beverage base enriched in dietary fiber.

The process of the invention used an organic acid to loosen the segment membranes. The citric acid and sodium hydroxide in the mixed water reacted with each other to generate sodium citrate, which is an ingredient of an electrolyte beverage with some efficacy and is edible. The table below gives main ingredients of the mixed water and its sensory evaluation.

| | |
|---|---|
| Pectin (%) | 0.39 |
| Insoluble dietary fiber (%) | 0.02 |
| Sodium citrate (%) | 0.15 |
| Total flavonoids (determined | 140 |
| by the Davis method) | |
| mg/1000 g | |
| Appearance | with no apparent precipitation, pale yellow |
| | in color, homogeneous and cloudy. |
| Taste | no significantly granular or |
| | particulate mouthfeel somewhat acidulous, |
| | and thick in texture |

It can be seen from the table that, compared with EXAMPLE 1, the two-step extraction process using an organic acid enabled the beverage to have an increased pectin content, a more stable appearance and a thicker texture, and that the mixed water or beverage had a reduced insoluble dietary fiber after subjecting to the filtration by a 100 mesh screen and had no significantly granular or particulate mouthfeel.

### Example 3

(1) blanching and peeling a grapefruit, and dividing the peeled grapefruit into segments, followed by soaking the segments in a 1.0 wt % acetic acid solution, and then stirring the mixture for 100 minutes at 10° C.;

(2) removing the segments processed at the step (1) from the solution and rinsing the segments with clean water, followed by soaking the segments in a 0.9 wt % potassium hydroxide solution, and then stirring the mixture for 50 minutes at 10° C. to obtain the segments without a membrane;

(3) rinsing the segments without a membrane obtained in the step (2) with clean water followed by subjecting to a canning process, and mixing acidic process water discharged in the step (1) and alkaline process water discharged in the step (2) to form a mixed water with a pH of 9 which was filtered via a 40 mesh screen, with a filtrate was directly used to make a beverage in a sterile workshop.

The process of the invention used an organic acid to loosen the segment membranes. The acetic acid and potassium hydroxide in the mixed water reacted with each other to generate potassium acetate, which is an ingredient of an electrolyte beverage with some efficacy and is edible. The table below gives main ingredients of the mixed water and its sensory evaluation.

| | |
|---|---|
| Pectin (%) | 0.21 |
| Insoluble dietary fiber (%) | 0.27 |
| Potassium acetate (%) | 0.75 |
| Total flavonoids (determined | 120 |
| by the Davis method) | |
| mg/1000 g | |
| Appearance | with slight precipitation, pale yellow in color, |
| | nonhomogeneous and cloudy. |
| Taste | slightly granular or particulate mouthfeel, |
| | mild alkali taste, and thin and light in texture |

It can be seen from the table that the mixed water subjected to filtration contained nutraceutical ingredients such as pectin and flavonoids and no harmful substance, and was safe and healthy. Also, the mixed water still had a 0.27% insoluble dietary fiber after the filtration by the 40 mesh screen.

### Example 4

(1) blanching and peeling a grapefruit, and dividing the peeled grapefruit into segments, followed by soaking the segments in a 0.3 wt % acetic acid solution, and then stirring the mixture for 30 minutes at 10° C.; increasing the concentration of the acetic acid solution to 1.0 wt % followed by further stirring for 70 minutes at 30° C.:

(2) removing the segments processed at the step (1) from the solution and rinsing the segments with clean water, followed by soaking the segments in a 0.9 wt % potassium hydroxide solution, and then stirring the mixture for 50 minutes at 10° C. to obtain the segments without a membrane;

(3) rinsing the segments without a membrane obtained in the step (2) with clean water followed by subjecting to a canning process, and mixing acidic process water discharged in the step (1) and alkaline process water discharged in the step (2) to form a mixed water with a pH of 3.5 which was filtered via a 60 mesh screen, with a filtrate directly used to make a beverage in a sterile workshop.

The process of the invention used an organic acid to loosen the segment membranes. The acetic acid and potassium hydroxide in the mixed water reacted with each other to generate potassium acetate, which is an ingredient of an electrolyte beverage with some efficacy and is edible. The table below gives main ingredients of the mixed water and its sensory evaluation.

| | |
|---|---|
| Pectin (%) | 0.37 |
| Insoluble dietary fiber (%) | 0.11 |
| Potassium acetate (%) | 0.27 |
| Total flavonoids (determined | 130 |
| by the Davis method) | |
| mg/1000 g | |
| Appearance | with minimal precipitation, pale yellow in |
| | color, homogeneous and cloudy. |
| Taste | slightly granular or particulate mouthfeel, |
| | somewhat acidulous, and thick in texture |

It can be seen from the table that, compared with EXAMPLE 3, thepiPtaep extraction process using an organic acid enabled the beverage to have an increased pectin content, a more stable appearance and a thicker texture, and that the mixed water or beverage still had a 0.11% insoluble dietary fiber after the filtration by the 60 mesh screen.

### Example 5

(1) blanching and peeling an Owari satsuma mandarin orange into segments, followed by soaking the segments in a 0.1 wt % phosphoric acid solution, and then stirring the mixture for 10 minutes at 30° C.; increasing the concentration of the phosphoric acid solution to 0.8 wt % followed by further stirring for 40 minutes at 50° C.;

(2) removing the segments processed at the step (1) from the solution and rinsing the segments with clean water, followed by soaking the segments in a 0.5 wt % potassium hydroxide solution, and then stirring the mixture for 10 minutes at 50° C. to obtain the segments without a membrane;

(3) rinsing the segments without a membrane obtained in the step (2) with clean water followed by subjecting to a canning process, and mixing acidic process water discharged in the step (1) and alkaline process water discharged in the step (2) to form a mixed water with a pH of 4.5 which was filtered via a 100 mesh screen, with a filtrate directly used to make a beverage in a sterile workshop; wherein, some of the beverage was concentrated to dryness to form a beverage base enriched in dietary fiber.

The process of the invention used an inorganic polyacid to loosen the segment membranes. The phosphoric acid and potassium hydroxide in the mixed water reacted with each other to generate potassium phosphate, which is an ingredient of an electrolyte beverage with some efficacy and is edible. The table below gives main ingredients of the mixed water and its sensory evaluation.

| | |
|---|---|
| Pectin (%) | 0.38 |
| Insoluble dietary fiber (%) | 0.02 |
| Potassium phosphate (%) | 0.25 |
| Total flavonoids (determined by | 135 |
| the Davis method) | |
| mg/1000 g | |
| Appearance | with no apparent precipitation, pale yellow |
| | in color, homogeneous and cloudy. |
| Taste | no significantly granular or particulate |
| | mouthfeel, somewhat acidulous, |
| | and thick in texture |

It can be seen from the table that, the two-step extraction process using an inorganic polyacid enabled the beverage to have an increased pectin content, a more stable appearance and a thicker texture, and that the mixed water or beverage had a reduced insoluble dietary fiber after subjecting to the filtration by the 100 mesh screen and had no significantly granular or particulate mouthfeel.

The process of the invention is simple, and suitable to mechanized production. Removal of the segment membranes can be enabled by the placement of the segments in launders containing acid and alkali solutions, where the segments are treated by the flowing solutions for a time period.

What is claimed is:

1. A process for processing mandarin segments with both acidic and alkaline process water being directly utilized, comprising steps of:
(1) blanching and peeling a mandarin, and dividing the peeled mandarin into segments, followed by soaking the segments in an organic acid or inorganic polyacid solution at a concentration of 0.1 to 1.0 wt %, and then stirring the mixture for 20 to 100 minutes at a temperature of 10 to 50° C.;
(2) removing the segments processed at the step (1) from the solution and rinsing the segments with clean water, followed by soaking the segments in an alkali solution at a concentration of 0.1 to 0.9 wt %, and then stirring the mixture for 10 to 50 minutes at a temperature of 10 to 50° C. to obtain the segments without a membrane; and
(3) mixing acidic water discharged in the step (1) and alkaline water discharged in the step (2) and then canning the mixed water.

2. The process according to claim 1, wherein, the mandarin comprises fruit of all Citrus species and hybrid varieties thereof other than kumquat and trifoliate orange.

3. The process according to claim 1, wherein, in the step (1), the segments are firstly subjected to be soaked in an organic acid or inorganic polyacid solution at a concentration of 0.1 to 0.3 wt % followed by stirring for 10 to 30 minutes at a temperature of 10 to 30° C., and then the concentration of the acid solution is increased to 0.3 to 1.0 wt % followed by further stirring for 10 to 70 minutes at a temperature of 30 to 50° C.

4. The process according to claim 1, wherein, the organic acid in the step (1) comprises any of citric acid, malic acid, tartaric acid, oxalic acid, succinic acid, lactic acid, acetic acid and the like, and the inorganic polyacid comprises phosphoric acid.

5. The process according to claim 1, wherein the alkali solution in the step (2) comprises either of sodium hydroxide and potassium hydroxide solutions.

6. The process according to claim 1, wherein the mixed water in the step (3) has a pH value within a range of 1.5 to 9, and the mixed water is subjected to filtration with a screen having a mesh size in a range of 40 to 100 mesh to give a filtrate, which can be directly used to make a beverage, a concentrated beverage or a beverage base, or can be processed into a functional food additive comprising dietary fiber and prebiotics.

7. The process according to claim 1, wherein the organic acid or inorganic polyacid solution used in the step (1) comprises an aqueous organic acid solution or an aqueous inorganic polyacid solution, respectively.

8. The process according to claim 1, wherein the alkali solution used in the step (2) comprises an aqueous sodium hydroxide solution or an aqueous potassium hydroxide solution.

9. The process according to claim 1, wherein in the step (1), after being stirred for 20 to 100 minutes at 10 to 50° C., the mixture is subjected to solid-liquid separation so as to obtain the segments and the acidic water.

10. The process according to claim 1, wherein in the step (2), after being stirred for 10 to 50 minutes at 10 to 50° C., the mixture is subjected to solid-liquid separation so as to obtain the segments without a membrane and the alkaline water.
